(19) United States
(12) Patent Application Publication
(10) Pub. No.: US 2014/0049908 A1
(43) Pub. Date: Feb. 20, 2014

(54) THERMAL MANAGEMENT SYSTEM

(71) Applicant: André Sloth ERIKSEN, Morgan Hill, CA (US)

(72) Inventor: André Sloth ERIKSEN, Morgan Hill, CA (US)

(21) Appl. No.: 13/589,225

(22) Filed: Aug. 20, 2012

(51) Int. Cl. G06F 1/20

(52) U.S. Cl. 361/679.53

(57) ABSTRACT

Embodiments of the disclosure may include a thermal management system. The thermal management system may include a cooling apparatus including a cooler block configured to retain at least one fluid channel, wherein the at least one fluid channel is configured to circulate a coolant within the cooler block and at least one plate mounted to the cooler block, wherein the at least one plate is comprised of a heat-conducting material, wherein the at least one fluid channel faces the at least one plate to be in thermal contact with the at least one plate. The system may also include a hard drive mounted onto the at least one plate, wherein heat generated by the hard drive is transferred to the at least one plate and removed from the at least one plate by the coolant circulating within the cooler block.

### TECHNICAL FIELD

The present disclosure is related generally to a thermal management system for cooling heat-generating components of a computer, server, or other data processing devices and systems.

### BACKGROUND

Electronic systems, such as, for example, computer systems include several electronic devices that generate heat during operation. For effective operation of the computer system, the temperature of these electronic devices must be maintained within acceptable limits by, for example, removing the heat generated by the devices. Bundling multiple computer systems together, such as, for example, in a server, further aggravates the heat removal problem by increasing the amount of heat that has to be removed from a relatively small area.

One known component of a computer system that generates heat is a hard disk drive (HDD) for storing and retrieving digital information. Such HDDs come in various configurations, such as, for example, non-volatile, random access, digital, and/or magnetic data storage devices.

Existing cooling systems for cooling a HDD are predominantly air-cooling systems with fans. These systems require relatively large amounts of space and prevent compactness in overall device or system design. Air-cooling systems generate a great deal of noise, are energy inefficient, and are susceptible to mechanical failures. In addition, the density of components in current computer systems obstructs the flow of air, reducing the heat-removing efficacy of such air-cooling systems.

Accordingly, the thermal management systems and related methods of the present disclosure are directed to improvements in the existing technology.

### SUMMARY OF THE DISCLOSURE

In one aspect of the disclosure, a cooling apparatus for removing heat generated by a hard drive may include a cooler block configured to retain at least one fluid channel, wherein the at least one fluid channel is configured to circulate a coolant within the cooler block, and at least one plate mounted to the cooler block, wherein the at least one plate is comprised of a heat-conducting material, wherein the at least one plate includes one or more mounting apertures onto which the hard drive is mounted, wherein heat generated by the hard drive is transferred to the at least one plate and removed from the at least one plate by the coolant circulating within the cooler block.

In another aspect of the disclosure, a thermal management system may include a cooling apparatus including a cooler block configured to retain at least one fluid channel, wherein the at least one fluid channel is configured to circulate a coolant within the cooler block and at least one plate mounted to the cooler block, wherein the at least one plate is comprised of a heat-conducting material, wherein the at least one fluid channel faces the at least one plate to be in thermal contact with the at least one plate. The system may also include a hard drive mounted onto the at least one plate, wherein heat generated by the hard drive is transferred to the at least one plate and removed from the at least one plate by the coolant circulating within the cooler block.

In yet another aspect of the disclosure, a thermal management system may include a cooling apparatus including a cooler block configured to retain at least one fluid channel, wherein the at least one fluid channel is configured to circulate a coolant within the cooler block, a first plate mounted to the cooler block, a second plate mounted to the cooler block opposite the first plate, wherein the at least one fluid channel faces the first and second plates to be thermal contact with the first and second plates, an inlet configured to deliver the coolant into the at least one fluid channel, and an outlet configured to discharge the coolant from the at least one fluid channel. The system may also include a first hard drive mounted onto the first plate and a second hard drive mounted onto the second plate, wherein heat generated by the first second hard drive and heat generated by the second hard drive are transferred to the first and second plates and removed from the first and second plates by the coolant circulating within the cooler block.

### BRIEF DESCRIPTION OF THE DRAWINGS

FIG. 1 illustrates a schematic depiction of a thermal management system, according to an exemplary disclosed embodiment;

FIG. 2 illustrates a perspective view of a cooling apparatus of the thermal management system of FIG. 1, according to an exemplary disclosed embodiment;

FIG. 3 illustrates another perspective view of a cooling apparatus of the thermal management system of FIG. 1, according to an exemplary disclosed embodiment;

FIG. 4 illustrates a plan view of a cooler block of the thermal management system of FIG. 1, according to an exemplary disclosed embodiment;

FIG. 5 illustrates a schematic depiction of another thermal management system, according to an exemplary disclosed embodiment;

FIG. 6 illustrates a perspective view of a cooling apparatus of the thermal management system of FIG. 5, according to an exemplary disclosed embodiment; and

FIG. 7 illustrates another perspective view of a cooling apparatus of the thermal management system of FIG. 5, according to an exemplary disclosed embodiment.

### DETAILED DESCRIPTION

The following detailed description illustrates a thermal management system by way of example and not by way of limitation. Although the description below describes an application of a thermal management system for one or more hard disk drives, embodiments of the disclosed thermal management systems may be applied to cool heat generating components in any application. For example, embodiments of the current disclosure may be used to cool portable computers that operate while being docked to a docking station. The description enables one of ordinary skill in the art to make and use the present disclosure for cooling any electronic component.

Reference will now be made to exemplary embodiments of the disclosure, examples of which are illustrated in the accompanying drawings. Wherever possible, the same reference numbers will be used throughout the drawings to refer to the same or like parts. Elements or parts designated using the same reference numbers in different figures perform similar functions. Therefore, for the sake of brevity, these elements may not be described with reference to every figure. In the description that follows, if an element is not described with reference to a figure, the description of the element made with reference to another figure applies.

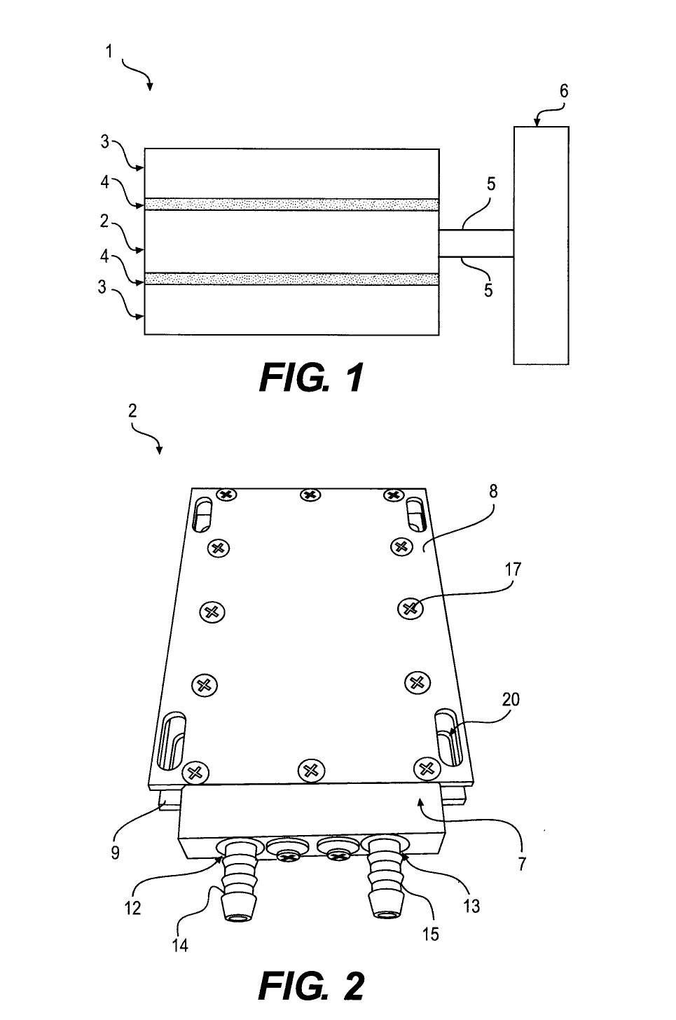

FIG. 1 is a schematic illustration of a thermal management system 1, according to an exemplary disclosed embodiment. Thermal management system 1 may include a cooling apparatus 2 configured to cool one or more electronic devices 3. In the exemplary embodiment shown in FIG. 1, cooling apparatus 2 may be a dual component cooling mechanism. That is, cooling apparatus 2 may be configured to simultaneously cool two electronic devices 3.

For the purposes of this disclosure, electronic device 3 may include a hard disk drive (HDD) for storing and retrieving digital information. Electronic device 3 may be any suitable HDD including, as examples, non-volatile, random access, digital, and/or magnetic data storage devices. It should be appreciated, however, that in certain other embodiments, electronic device 3 may include any other heat generating device. For example, electronic device 3 may include, without limitation, any type of integrated circuit or other device (including, as examples, a CPU, a GPU, memory, a power supply, a controller, etc.) that are found in typical computer systems.

As alluded to above, cooling apparatus 2 may be configured to cool HDDs 3 by being in thermal contact with HDDs 3. In certain embodiments, cooling apparatus 2 may be configured to indirectly cool HDDs 3. For example, and as shown in FIG. 1, cooling apparatus 2 may be in thermal contact with HDDs 3 via a heat transfer medium 4. Heat transfer medium 4 may include any suitable medium configured to transfer heat between cooling apparatus 2 and HDDs 3, such as, for example, thermal grease or a thermal pad. In other embodiments, cooling apparatus 2 may be configured to directly cool HDDs 3 by being in direct contact with HDDs 3.

Thermal management system 1 may deliver a suitable coolant to cooling apparatus 2. The coolant may pass through cooling apparatus 2 to remove heat from, and thereby cool, HDDs 3. Fluid lines 5 may deliver the coolant to and from cooling apparatus 2 and may couple the coolant to a suitable heat exchanger 6. In some embodiments, thermal management system 1 may also include pumps or other liquid moving devices (not shown) to assist in transferring the coolant to and from cooling apparatus 2. Alternatively, some configurations of thermal management system 1 may not include a pump, and instead, may rely upon the expansion and contraction of the coolant as it absorbs and dissipates heat to propel the coolant to and from cooling apparatus 2.

Any liquid, such as, for example, glycol, water, alcohol, and mixtures thereof may be used as the coolant. It should also be appreciated that the coolant may include a dielectric fluid incapable of conducting electricity. Using the dielectric fluid may therefore prevent damage to the components of HDDs 3 (or any other devices near HDDs 3), if a leak in thermal management system 1 were to occur. Non-limiting examples of such dielectric fluids may include deionized water, mineral oils, and mixtures thereof. Such dielectric fluids may also be fluorescent. Although the coolant is described as a liquid, in some embodiments, a phase change material may be used as the coolant. In these embodiments, a coolant in a liquid phase may transform to a gaseous phase after absorption of heat at cooling apparatus 2. The coolant may transform back to the liquid phase after transferring the absorbed heat from cooling apparatus 2. In some embodiments, valves or other known fluid control devices (not shown) may be provided in thermal management system 1 to control the flow of the coolant therein.

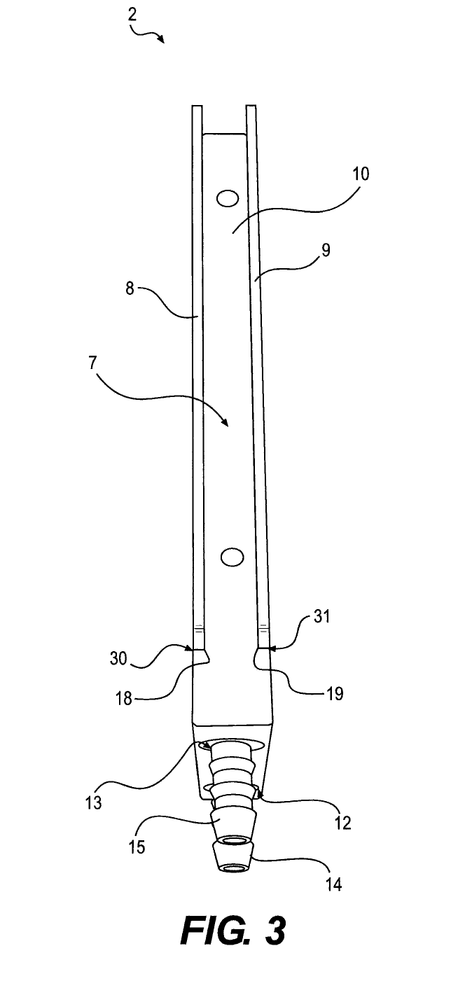

FIGS. 2 and 3 illustrate perspective views of cooling apparatus 2, according to exemplary disclosed embodiments. Cooling apparatus 2 may include a cooler block 7, a first heat-conducting cold plate 8, and a second heat-conducting cold plate 9.

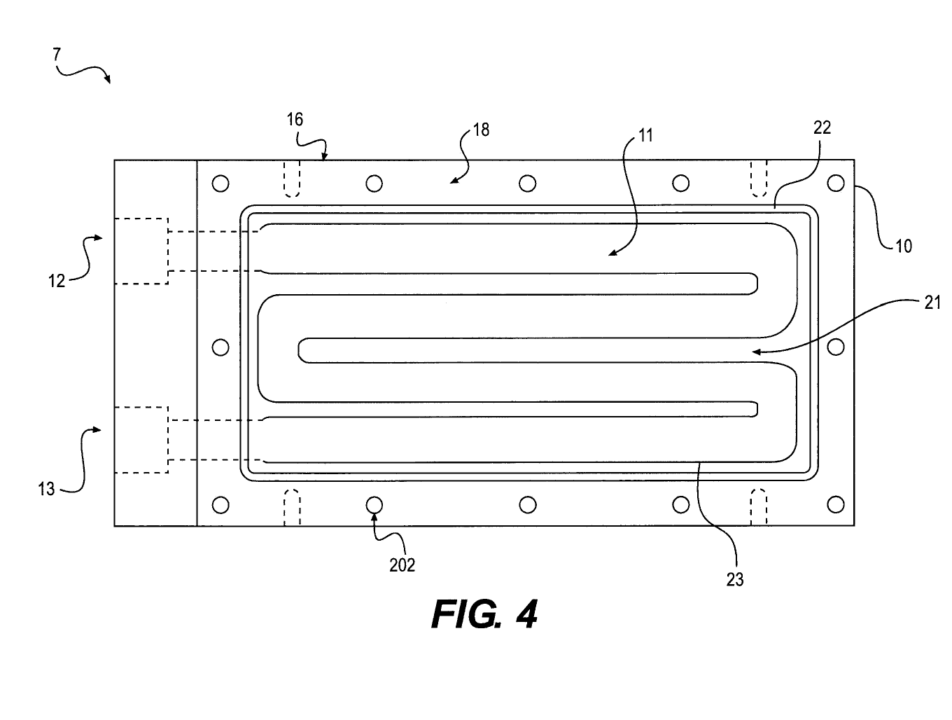

Cooler block 7 may include a frame 10 to retain one or more fluid conduits configured to receive, circulate, and discharge the coolant. As shown in FIG. 4, for example, at least one fluid channel 11 for receiving and discharging the coolant may be retained by frame 10.

Cooler block 7 may also include an inlet 12 and an outlet 13. Inlet 12 may be configured to deliver the coolant to fluid channel 11, and outlet 13 may be configured to discharge the coolant from fluid channel 11. Moreover, inlet 12 may include a connection end 14, and outlet 13 may include a connection end 15. Connection ends 14, 15 may be configured to be fluidly coupled to the appropriate fluid lines 5 in fluid-tight arrangements. In certain embodiments, and as shown in FIGS. 2 and 3, connection ends 14, 15 may include a threaded arrangement configured to engage corresponding grooves of fluid lines 5. It should be appreciated, however, that connection ends 14, 15 may include any other suitable configuration to connect cooling apparatus 2 to fluid lines 5. For example, connection ends 14, 15 may include a barbed surface configured to connect to fluid lines 5 via an interference fit arrangement.

In certain embodiments, each of inlet 12 and outlet 13 may include a fluid connector or fluid connector interface configured to form a fluid-tight connection between fluid lines 5 and cooling apparatus 2, and readily connect and disconnect fluid lines 5 to and from cooling apparatus 2. For example, each of inlet 12 and outlet 13 may include one or more features of the fluid connectors disclosed in U.S. application Ser. No. 13/481,210, which is incorporated herein by reference in its entirety.

First heat-conducting cold plate 8 and second heat-conducting cold plate 9 may be mounted on opposite sides of frame 10. Once mounted onto frame 10, first heat-conducting cold plate 8 and second heat-conducting cold plate 9 may be in thermal contact with the coolant traveling through fluid channel 11. As shown in FIG. 2, first heat-conducting cold plate 8 may be mounted to frame 10 via a plurality of fasteners 17. Although not shown in FIG. 2, fasteners 17 may also mount second heat-conducting cold plate 9 to frame 10. It should be appreciated, however, that first heat-conducting cold plate 8 and second heat-conducting cold plate 9 may be mounted onto frame 10 by any other suitable means, such as, for example, welding, adhesives, and the like. Moreover, in certain other embodiments, first heat-conducting cold plate 8 and second heat-conducting cold plate 9 may be integrally formed with frame 10 as a unitary piece of material. As shown in FIG. 3, frame 10 may also include a first recessed section 18 into which first heat-conducting cold plate 8 may be disposed, and a second recessed section 19 into which second heat-conducting cold plate 9 may be disposed. First recessed section 18 may provide a first substantially flush interface 30 between frame 10 and first heat-conducting cold plate 8, and second recessed section 19 may provide a second substantially flush interface 31 between frame 10 and second heat-conducting cold plate 9, thereby providing a compact structure of cooling apparatus 2 for cooling HDDs 3.

First heat-conducting cold plate 8 and second heat-conducting cold plate 9 may include one or more mounting apertures 20 to facilitate the coupling of cooling apparatus 2 to HDDs 3. Any suitable removable fasteners, such as, for examples, screws, nuts and bolts, and the like, may be coupled to HDDs 3, delivered through apertures 20, and fastened to first heat-conducting cold plate 8 and second heat-conducting cold plate 9. Moreover, the removable fasteners may be disengaged from first heat-conducting cold plate 8 and/or second heat-conducting cold plate 9 to service or replace one or both HDDs 3 and/or cooling apparatus 2. It should also be appreciated that in certain embodiments, heat transfer medium 4 may include one or more apertures substantially aligned with mounting apertures 20 through which the removable fasteners may be disposed.

Thermal contact between HDDs 3 and first heat-conducting cold plate 8 and second heat-conducting cold plate 9 may cool HDDs 3. More particularly, first heat-conducting cold plate 8 and second heat-conducting cold plate 9 may be configured to transfer heat generated by HDDs 3 to the coolant circulating within cooling apparatus 2. First heat-conducting cold plate 8 and second heat-conducting cold plate 9 may comprise any suitable heat-conducting material configured to facilitate heat transfer between HDDs 3 and the coolant. For example, first heat-conducting cold plate 8 and second heat-conducting cold plate 9 may be comprised of aluminum, copper, stainless steel, and the like. It should also be appreciated that first heat-conducting cold plate 8 and second heat-conducting cold plate 9 (and/or heat transfer medium 4) may be appropriately sized such that an entire surface area of each HDD 3 coupled to cooling apparatus 2 is in contact with first heat-conducting cold plate 8 or second heat-conducting cold plate 9 (and/or heat transfer medium 4).

In certain embodiments, portions of cooling apparatus 2 not in thermal contact with HDDs 3 and/or heat transfer medium 4 may include an insulating material to maintain heat transfer between only HDDs 3 and the coolant. For example, only first heat-conducting cold plate 8 and second heat-conducting cold plate 9 may be comprised of a heat-conducting material, while frame 10, inlet 12, and outlet 13 may be comprised of or covered with an insulating material incapable of transferring and/or conducting heat, such as, for example, any suitable plastics or neoprene. As such, heat removed by the coolant may be prevented from dissipating through cooling apparatus 2 and undesirably raising the temperature of the surrounding environment (e.g., other components of a computer system). Moreover, the insulating material may prevent heat from the surrounding environment transferring to the coolant and undesirably raising the temperature of the coolant as it is circulated through cooling apparatus 2. The insulating material may therefore maintain efficient cooling by cooling apparatus 2.

FIG. 4 illustrates a plan view of cooler block 7 without first heat-conducting cold plate 8 and second heat-conducting cold plate 9, according to an exemplary embodiment. As alluded to above, frame 10 may enclose fluid channel 11. The coolant may be delivered through inlet 12 and into fluid channel 11, and circulate within cooler block 7 to remove heat from HDDs 3. The coolant may then be discharged through outlet 13, thereby removing heat from cooling apparatus 2.

Frame 10 may include a first open side surface 21 facing first heat-conducting cold plate 8. First open side surface 21 may allow the coolant flowing through fluid channel 11 to come into thermal contact (either direct or indirect) with first heat-conducting cold plate 8 when first heat-conducting cold plate 8 is mounted onto frame 10. Although not illustrated in FIG. 4, it should also be appreciated that frame 10 may include a second open side surface facing second heat-conducting cold plate 9 to provide thermal contact (either direct or indirect) between the coolant and second heat-conducting cold plate 9. Frame 10 may also include an outer periphery 16 onto which first heat-conducting cold plate 8 and second heat-conducting cold plate 9 may be mounted. A plurality of apertures 202 for receiving fasteners 17 may be positioned around outer periphery 16. Cooler block 7 may also include a sealing mechanism 22 for providing a fluid-tight interface between frame 10 and first heat-conducting cold plate 8 and second heat-conducting cold plate 9. Sealing mechanism 22 may encase the perimeters of first open side surface 21 and the second open side surface, and may include any suitable resilient material for forming a seal, such as, for example, an elastomeric gasket or O-ring.

Fluid channel 11 may be bound by walls 23. Walls 23 may extend through a width of frame 10 between first open side surface 21 and the second open side surface. Walls 23 may also extend along a length of first open side surface 21 and the second open side surface, and may include a generally “S” or “serpentine” path. It should be appreciated that walls 23 may form any other suitably shaped path, such as, for example, zigzag-shaped or circular-shaped. Moreover, walls 23 may comprise any suitable heat-conducting material, such as, for example, aluminum or copper, to facilitate heat removal from first heat-conducting cold plate 8 and second heat-conducting cold plate 9 to the coolant. Although not illustrated, it should be appreciated that walls 23 may include one or more breaking features extending therefrom configured to introduce turbulence into the flow of coolant. The one or more breaking features may include, as example, any suitable nubs, protuberances, barbs, pins, fins, and the like. Turbulence in the coolant flow may break boundary layers in the coolant, thereby assuring that first heat-conducting cold plate 8 and second heat-conducting cold plate 9 comes into contact with the coolant and effectively transfer heat to the coolant. In other embodiments, the one or more breaking features may be disposed on the surfaces of first and second heat-conducting cold plates 8, 9 facing fluid channel 11 and may come into contact with the coolant flowing through fluid channel 11.

In certain other embodiments, fluid channel 11 may be completely encased by a tubular member, and the tubular member may be in contact (either direct or indirect) with first heat-conducting cold plate 8 and second heat-conducting cold plate 9. In such embodiments, the tubular member may comprise a heat-conducting material, such as, for example, aluminum or copper.

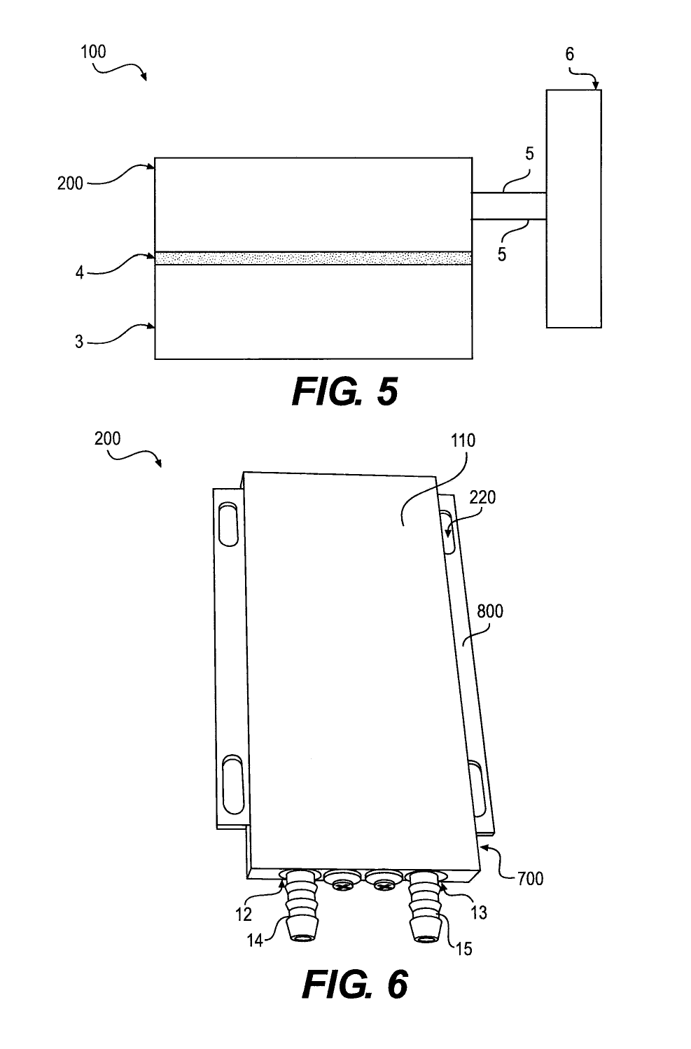

FIG. 5 is a schematic illustration of another thermal management system 100, according to an exemplary disclosed embodiment. Thermal management system 100 may include similar features as thermal management system 1. Thermal management system 100, however, may include a cooling apparatus 200 configured to cool a single HDD 3.

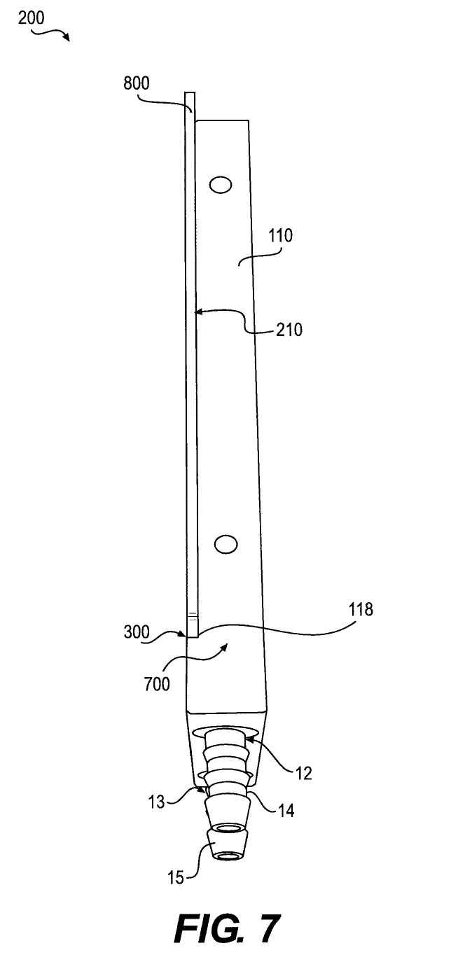

FIGS. 6 and 7 illustrate perspective views of cooling apparatus 200, according to exemplary disclosed embodiments. Cooling apparatus 200 may include a cooler block 700 and a heat-conducting cold plate 800. Similar to cooler block 7, cooler block 700 may include a vessel 110 for retaining one or more fluid channels configured to receive, circulate, and discharge the coolant. Vessel 110, however, includes only a single open side surface 210 facing heat-conducting cold plate 800, while the side surface of vessel 110 opposite open side surface 210 may be enclosed. In addition, cooler block 700 may include inlet 12 and outlet 13 configured to deliver and discharge the coolant to and from the one or more fluid channels. Inlet 12 and outlet 13 may also include connection ends 14, 15 to fluidly connect to fluid lines 5 (FIG. 5).

Although not illustrated in FIGS. 6 and 7, it should be appreciated that heat-conducting cold plate 800 may be mounted onto an outer periphery of vessel 110 by suitable fasteners similar to cooling apparatus 2. As shown in FIG. 7, vessel 110 may also include a recessed section 118 into which heat-conducting cold plate 800 may be disposed. Recessed section 118 may provide a substantially flush interface 300 between vessel 110 and heat-conducting cold plate 800, thereby providing a compact structure of cooling apparatus 200 for cooling HDD 3. Furthermore, heat-conducting cold plate 800 may include one or more mounting apertures 220 to facilitate the coupling of cooling apparatus 200 to HDD 3.

Similar to cooling apparatus 2, thermal contact between HDD 3 and heat-conducting cold plate 800 may cool HDD 3. Heat-conducting cold plate 800 may be configured to transfer heat generated by HDD 3 to the coolant circulating within cooling apparatus 200. Heat-conducting cold plate 800 may comprise any suitable heat-conducting material, such as, for example, aluminum, copper, stainless steel, and the like, and may include one or more breaking features, such as, for example, fins, pins, etc., to introduce turbulence in the coolant. Heat-conducting cold plate 800 and/or heat transfer medium 4 may also be appropriately sized such that an entire surface area of HDD 3 coupled to cooling apparatus 200 is in contact with heat-conducting cold plate 800 and/or heat transfer medium 4.

In addition, portions of cooling apparatus 200 not in thermal contact with HDD 3 and/or heat transfer medium 4 may include an insulating material to maintain heat transfer between only HDD 3 and the coolant. For example, only heat-conducting cold plate 800 may be comprised of a heat-conducting material, while vessel 110, inlet 12, and outlet 13 may be comprised of or covered with an insulating material incapable of transferring and/or conducting heat, such as, for example, any suitable plastics or neoprene.

Thermal management system 1, 100 may provide a number of features. For example, thermal management system 1, 100 may provide a more simplified and compact system for cooling one or more HDDs 3. Because thermal management system 1, 100 may utilize a coolant to cool HDD 3, the use of moving parts (e.g., fans), which may be susceptible to mechanical failures and may generate a great deal of noise, may be obviated. Moreover, cooling apparatus 2, 200 may provide a compact, box-like structure onto which HDD 3 simply may be mounted to remove heat generated by HDD 3.

It will be apparent to those skilled in the art that various modifications and variations can be made to the disclosed thermal management systems. Other embodiments will be apparent to those skilled in the art from consideration of the specification and practice of the disclosed thermal management systems. It is intended that the specification and examples be considered as exemplary only, with a true scope being indicated by the following claims and their equivalents.

What is claimed is:

1. A cooling apparatus for removing heat generated by a hard drive, comprising:
a cooler block configured to retain at least one fluid channel, wherein the at least one fluid channel is configured to circulate a coolant within the cooler block; and
at least one plate mounted to the cooler block, wherein the at least one plate is comprised of a heat-conducting material, wherein the at least one plate includes one or more mounting apertures onto which the hard drive is mounted, wherein heat generated by the hard drive is transferred to the at least one plate and removed from the at least one plate by the coolant circulating within the cooler block.

2. The cooling apparatus of claim 1, wherein the cooler block includes a frame having an outer periphery, a first open side surface, and a second open side surface.

3. The cooling apparatus of claim 2, wherein the at least one fluid channel is encased within the frame and faces the first open side surface and the second open side surface.

4. The cooling apparatus of claim 3, wherein the at least one plate includes a first plate and a second plate mounted on opposite sides of the frame.

5. The cooling apparatus of claim 4, wherein the first plate is mounted onto the outer periphery of the frame and faces the first open side surface, and the second plate is mounted onto the outer periphery of the frame and faces the second open side surface.

6. The cooling apparatus of claim 5, wherein the frame includes a first recessed section into which the first plate is disposed, and a second recessed section into which the second plate is disposed, wherein the frame and the first plate form a first substantially flush interface, and the frame and the second plate form a second substantially flush interface.

7. The cooling apparatus of claim 1, wherein the cooler block includes a vessel having an outer periphery, an open side surface, and an enclosed side surface opposite the open side surface.

8. The cooling apparatus of claim 7, wherein the at least one fluid channel is disposed within the vessel and faces the open side surface.

9. The cooling apparatus of claim 8, wherein the at least one plate is mounted onto the outer periphery of the vessel and faces the open side surface, wherein the vessel and the at least one plate form a substantially flush interface.

10. The cooling apparatus of claim 1, further comprising an inlet configured to deliver the coolant into the at least one fluid channel and an outlet configured to discharge the coolant from the at least one fluid channel.

11. The cooling apparatus of claim 1, further comprising a heat transfer medium positioned on the at least one plate and configured to be in thermal contact with the at least one plate and the hard disk.

12. The cooling apparatus of claim 1, wherein the heat conducting material of the at least one plate includes one of copper and aluminum.

13. The cooling apparatus of claim 1, further comprising a sealing mechanism positioned between the at least one plate and the cooler block and configured to form a fluid-tight seal therebetween.

14. A thermal management system, comprising:
a cooling apparatus including:
a cooler block configured to retain at least one fluid channel, wherein the at least one fluid channel is configured to circulate a coolant within the cooler block; and
at least one plate mounted to the cooler block, wherein the at least one plate is comprised of a heat-conducting material, wherein the at least one fluid channel faces the at least one plate to be in thermal contact with the at least one plate; and
a hard drive mounted onto the at least one plate, wherein heat generated by the hard drive is transferred to the at least one plate and removed from the at least one plate by the coolant circulating within the cooler block.

15. The thermal management system of claim 14, wherein the cooler block is comprised of a thermally-insulating material.

16. The thermal management system of claim 14, wherein the at least one plate includes one or more mounting apertures onto which the hard drive is removably fastened.

17. The thermal management of claim 14, wherein the cooler block includes a recessed section into which the at least one plate is disposed, wherein the cooler block and the at least one plate form a substantially flush interface.

18. A thermal management system, comprising:
a cooling apparatus including:
a cooler block configured to retain at least one fluid channel, wherein the at least one fluid channel is configured to circulate a coolant within the cooler block;
a first plate mounted to the cooler block;
a second plate mounted to the cooler block opposite the first plate, wherein the at least one fluid channel faces the first and second plates to be thermal contact with the first and second plates;
an inlet configured to deliver the coolant into the at least one fluid channel; and
an outlet configured to discharge the coolant from the at least one fluid channel;
a first hard drive mounted onto the first plate; and
a second hard drive mounted onto the second plate, wherein heat generated by the first second hard drive and heat generated by the second hard drive are transferred to the first and second plates and removed from the first and second plates by the coolant circulating within the cooler block.

19. The thermal management system of claim 18, wherein the first plate and the second plate are comprised of a heat-conducting material, and the cooler block is comprised of a thermally-insulating material.

20. The thermal management system of claim 18, wherein each of the first plate and second plate includes one or more mounting apertures onto which the first hard drive and the second hard drive are removably fastened.
